(19) United States
(12) Patent Application Publication
(10) Pub. No.: US 2021/0187808 A1
(43) Pub. Date: Jun. 24, 2021

(54) INJECTION DEVICE OF AN INJECTION MOULDING MACHINE

(71) Applicant: Dr. Boy GmbH & Co. KG, Neustadt-Fernthal (DE)

(72) Inventor: Alfred Schiffer, Obersteinebach (DE)

(21) Appl. No.: 17/124,984

(22) Filed: Dec. 17, 2020

(30) Foreign Application Priority Data
Dec. 18, 2019 (DE) 102019134955.9

(51) Int. Cl. B29C 45/76; B29C 45/50

(52) U.S. Cl. CPC B29C 45/76; B29C 45/5008; B29C 2045/5056; B29C 2945/76568; B29C 2945/7618; B29C 2945/76458; B29C 2945/76605; B29C 2945/76013

(57) ABSTRACT

An injection device for an injection moulding machine includes an injection drive, which is designed so as to rotate an injection spindle relative to a spindle nut, and injection slide, which is connected to the spindle nut in a rotationally rigid manner on a lateral surface and held so as to be movable along a slide guide, a guide housing, on which a plasticizing cylinder is held, a bearing housing, in which a driveshaft is rotatably supported and which is connected to the injection slide, as well as a metering drive, which is fastened on the injection slide and designed so as to rotate the driveshaft. A force measuring device is externally fastened on a force transmission component that is arranged between the bearing housing and the spindle nut and lies in the flux of force of the injection device.

### BACKGROUND

The disclosure pertains to an injection device for an injection moulding machine, particularly a hydraulically or electromechanically driven injection-moulding machine, for melting and injecting a plastic mass into a mould of the injection moulding machine, comprising an injection drive, which has an injection spindle and a spindle nut and is designed so as to rotate the injection spindle relative to the spindle nut, an injection slide, which is connected to the spindle nut in a rotationally rigid manner on one lateral surface and held so as to be movable along a slide guide, a guide housing, on which a plasticizing cylinder is held on the side facing away from the injection slide, a bearing housing, which is arranged between the guide housing and the injection slide and in which a driveshaft is rotatably supported, wherein said driveshaft can be drive-connected to an injection screw that is movably arranged within the plasticizing cylinder, and wherein said bearing housing is connected to the injection slide on a lateral surface of the injection slide facing away from the spindle nut, as well as a metering drive that is fastened on the injection slide and designed so as to rotate the driveshaft.

Injection devices for injection moulding machines of the above-described type are known from the prior art. In injection moulding, the injection speed, the accuracy and the pressure are controlled by special apparatuses. For example, an electric injection moulding machine utilizes a servomotor, which can use a feedback control for the speed and for the position. However, the servomotor cannot measure the injection force. The injection force is usually determined by additionally arranging a load cell equipped with strain gauges such that it lies in the flux of force of the injection device, wherein the load cell is realized in the form of a specially fabricated and annular ancillary component that is arranged, for example, between the spindle nut and the plasticizing cylinder. This ancillary component has to be realized in a deformable manner in order to carry out the force measurement, but at the same time also has to be massive in accordance with the prevailing forces because it is arranged such that it lies in the flux of force. This ancillary component therefore represents an additional component, which is to be installed on the injection moulding machine and the attachment of which requires corresponding space for fastening elements, wherein such an ancillary component disadvantageously increases the assembly effort of the entire machine. Experience has shown that load cells with strain gauges (DMS), but without a correspondingly shaped ancillary component, are unsuitable because they do not measure in a sufficiently accurate manner. In order to realize a sensitive and therefore accurate measurement, the ancillary component would have to be significantly weakened such that an adequate deformation takes place and a sufficiently sensitive measurement can be carried out.

### BRIEF DESCRIPTION

The present disclosure is based on the objective of making available an option for measuring a force, by means of which the injection force can be determined as exactly as possible and the disadvantages known from the prior art can be eliminated.

According to one aspect, this objective is attained in an injection device for an injection moulding machine of the initially cited type in that a force measuring device, which determines at least an injection force, is externally fastened on a force transmission component that is arranged between the bearing housing and the spindle nut and lies in the flux of force of the injection device.

Advantageous and practical embodiments and enhancements are disclosed in the dependent claims.

The present disclosure makes available an injection device for an injection moulding machine that is characterized by a simple construction. The need for an additionally fabricated component is eliminated due to the fact that the force measuring device is externally arranged on a force transmission component, particularly on an existing force transmission component of the injection device, such that the manufacturing costs are reduced. The assembly effort, in particular, is advantageously reduced in comparison with solutions known from the prior art, in which an ancillary component is integrated and installed in the flux of force, wherein the subject disclosure also makes it possible to realize a shorter structural shape of the injection moulding machine because an ancillary component to be installed in the flux of force is no longer required. Since no deformable ancillary component to be installed in the flux of force is provided, the force application during the operation of the injection device takes place directly and with a more rigid machine axis, which in turn has positive effects on the motion control of the injection device. The present disclosure also makes it possible to realize a lower weight of the injection device than in solutions known from the prior art, wherein this has advantageous effects on a higher dynamic of the disclosed injection device, which is synonymous with an improved controllability due to the increased dynamic. Due to the external arrangement of the force measuring device, the subject disclosure also allows a simple and fast exchange, e.g. of a defective force measuring device, because the force measuring device is not installed in the direct flux of force. According to one aspect, the mechanical design of the injection device therefore is realized simpler, smaller, more cost-efficient, lighter and more rigid, wherein the more rigid construction causes a superior reproducibility at higher reaction speed during dynamic injection processes.

According to an embodiment, it is proposed that the force transmission component is the injection slide. The injection slide is particularly well suited for a sensitive force measurement.

According to another embodiment, it is proposed that the injection slide and the bearing housing are realized in the form of an integral component in order to reduce the manufacturing costs and the assembly effort. In this aspect, integral means that the injection slide and the bearing housing are cast or injection-moulded in one manufacturing process and therefore form a single component.

According to an embodiment, it is particularly advantageous if the force measuring device is realized in the form of a piezoresistive strain sensor. This piezoresistive strain sensor lies passively in the flux of force and is subjected, for example, to a compression during the injection process. In this case, the prevailing slight compression on the outer wall of the injection slide, which transmits the force from the spindle nut to the bearing housing, is very accurately measured by the piezoresistive strain sensor due to its measuring sensitivity. It should be noted that a mere piezoelectric sensor is generally not suitable for measuring purposes on an injection device because the piezoelectric sensor operates based on a charge measurement and the measurement therefore is only quasi-static, i.e. the measured value would drift downward over time because the charge from the system is lost and the piezoelectric sensor would therefore require constant recalibration that, however, subjects the process to an undesirable dispersion. Consequently, the force measuring device is realized in the form of a piezoresistive strain sensor that combines the advantages of static measuring signals and high sensitivity.

The instant disclosure accordingly proposes that the piezoresistive strain sensor is externally fastened on the injection slide in the direct flux of force. In the prior art, the measurement is realized with an ancillary component, which is additionally installed in the flux of force and therefore arranged actively in the flux of force, whereas the piezoresistive strain sensor according to the subject disclosure is in fact also arranged in the direct flux of force, but not arranged actively in the flux of force, i.e. passively on a component lying in the flux of force.

According to another embodiment, it is proposed that the piezoresistive strain sensor is realized with two freely programmable, independent measuring ranges for the force measurement. In this case, the two measuring ranges may differ by a factor of 10. This means that, for example, a range with high forces (injection time) can be processed by the piezoresistive strain sensor with a lower resolution whereas the piezoresistive strain sensor can be switched over to a higher resolution during plasticizing such that a superior measurement of the metering pressure can be achieved.

According to an embodiment, it is particularly advantageous if the piezoresistive strain sensor is designed for an indirect force measurement by measuring the force-proportional strain of the surface of the force transmission component.

According to an embodiment, it is advantageous to align the piezoresistive strain sensor in the longitudinal direction of the injection spindle in order to achieve an accurate and sensitive measurement.

According to an embodiment, which likewise aims to achieve an accurate and sensitive measurement, it is proposed that the piezoresistive strain sensor has a sensor housing that is fastened on the surface of the force transmission component at a distance from its surface.

According to another embodiment, it is proposed that the injection drive comprises a motor-driven toothed wheel and a toothed belt that is drive-connected to the injection spindle. This makes it possible to realize a compact structural shape of the injection device without having to noticeably increase the machine length.

In addition, the present disclosure also proposes the utilization of a piezoresistive strain sensor for measuring at least the injection force of an injection device of an injection moulding machine.

It goes without saying that the characteristics described above and below not only can be used in the respectively cited combination, but also in other combinations or individually without thereby deviating from the scope of the present disclosure.

Other details, characteristics and advantages of the object of the subject disclosure can be gathered from the following description in connection with the drawings, in which an exemplary and preferred embodiment is illustrated.

### BRIEF DESCRIPTION OF THE DRAWINGS

In these drawings:

FIG. 1 shows a perspective view of an injection device according to one aspect,

FIG. 2 shows another perspective view of the injection device illustrated in FIG. 1,

FIG. 3 shows a detailed perspective view of an injection slide and a force measuring device of the injection device,

FIG. 4 shows a sectional view of a region of the injection slide and a bearing housing of the injection device,

FIG. 5 shows a perspective view of the bearing housing, the injection slide and a spindle nut of the injection device, and

FIG. 6 shows a perspective view of the bearing housing and the injection slide of the injection device.

### DETAILED DESCRIPTION

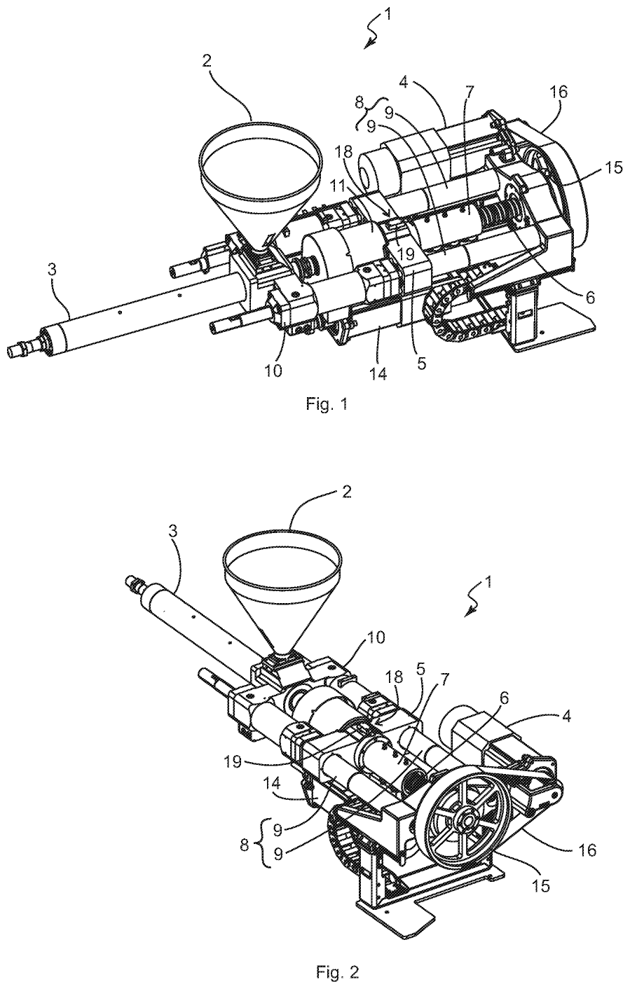

FIGS. 1 and 2 respectively show a perspective view of an injection device 1 according to one exemplary embodiment. The injection device 1 serves for melting and injecting a plastic mass into a mould of an injection moulding machine that is operated hydraulically or electromechanically. The plastic mass to be melted is conventionally fed to a plasticizing cylinder 3 through a hopper 2. In the exemplary embodiment, the injection device 1 comprises an injection drive 4 in the form of a servomotor and an injection slide 5, wherein the injection drive 4 has an injection spindle 6 and a spindle nut 7 and the injection spindle 6 is designed so as to rotate relative to the spindle nut 7. The injection slide 5 is connected to the spindle nut 7 in a rotationally rigid manner on one of its lateral surfaces. Furthermore, the injection slide 5 is held so as to be movable along a slide guide 8, wherein the slide guide 8 is formed by two side rails 9 that extend laterally of and parallel to the spindle nut 7. The injection device 1 also has a guide housing 10, on which the plasticizing cylinder 3 is held on the side facing away from the injection slide 5. The injection device 1 furthermore has a bearing housing 11, which is arranged between the guide housing 10 and the injection slide 5 and in which a driveshaft 12 is rotatably supported, wherein said bearing housing is connected to the injection slide 5 on a lateral surface of the injection slide 5 facing away from the spindle nut 7. The driveshaft 12 is illustrated, for example, in FIG. 5 and can be drive-connected to an injection screw that is movably arranged within the plasticizing cylinder 3, wherein the not-shown injection screw is rotatable within the plasticizing cylinder 3, as well as movable in the longitudinal direction of the plasticizing cylinder 3. The injection device 1 also has a metering drive 14 that is fastened on the injection slide 5, wherein said metering drive is realized in the form of a servomotor and designed so as to rotate the driveshaft 12. According to FIGS. 1 and 2, the injection drive 4 comprises a motor-driven toothed wheel 15 and a toothed belt 16 that is drive-connected to the injection spindle 6.

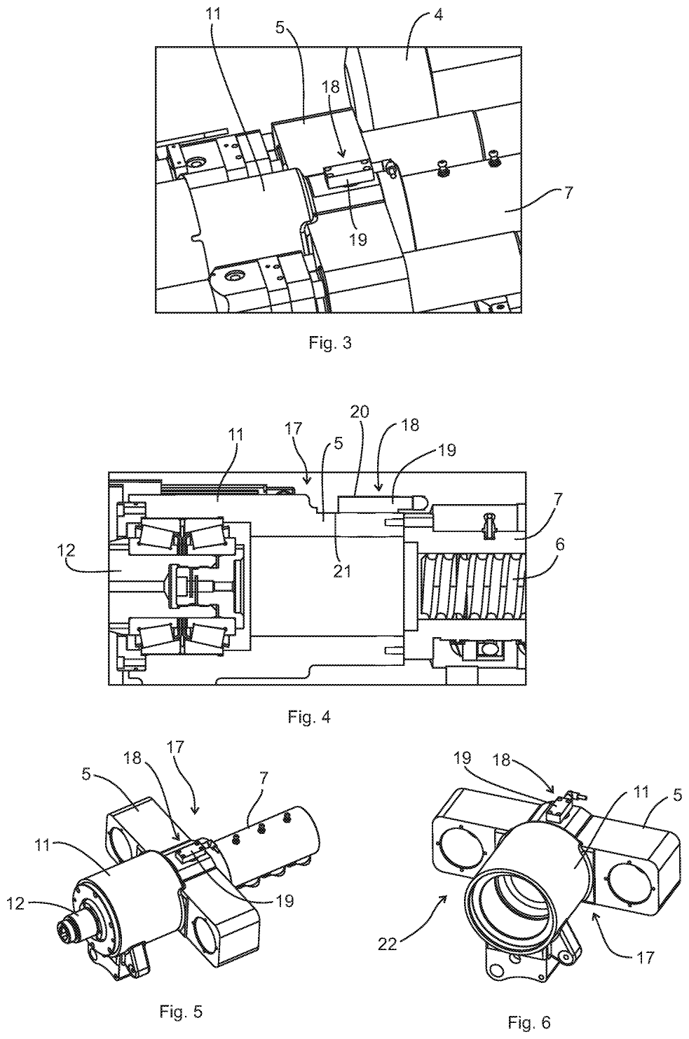

In the illustrated embodiment, the injection device 1 has a mechanical force transmission component 17, which is arranged in the direct flux of force between the injection spindle 6 and the injection screw arranged in the plasticizing cylinder 3 or the bearing housing 11, respectively. The deformation in the form of a strain or a compression is measured directly on this force transmission component 17 due to the attachment of a force measuring device 18. According to one aspect, the force measuring device 18 for determining at least an injection force is externally fastened on the force transmission component 17 that is arranged between the bearing housing 11 and the spindle nut 7 and lies in the flux of force of the injection device 1, e.g. as illustrated in FIG. 3. In the exemplary embodiment illustrated in the figures, the force transmission component 17 is the injection slide 5.

According to one aspect, the force measuring device 18 is realized in the form of a piezoresistive strain sensor 19 and has a sensor housing 20 (e.g. see FIG. 4). The figures altogether show that the piezoresistive strain sensor 19 is arranged on the injection slide 5 in the direct flux of force and externally fastened on the injection slide 5. In this case, the sensor housing 20 of the piezoresistive strain sensor 9 is fastened on the surface 21 of the force transmission component 17 at a distance from its surface 21. For example, the piezoresistive strain sensor 19 may be mounted on the surface 21 at a distance from this surface 21 with four screws such that there is no contact between the sensor housing 20 and the mounting surface 21. The sensor housing 20 may be mounted, for example, at a distance of 0.3 mm from the surface 21. In this case, the piezoresistive strain sensor 19 is aligned in the longitudinal direction of the injection spindle 6 in order to achieve the best measuring results. The cable for transmitting the measured values, which leads out of the sensor housing 20, has to be installed in such a way that it is decoupled from tensile stresses, compressive stresses and bending stresses, as well as vibrations from the piezoresistive strain sensor 19, and is to this end advantageously fixed on the surface 21. The piezoresistive strain sensor 19 is designed for an indirect force measurement by measuring the force-proportional strain or compression of the surface 21 of the force transmission component 17 and may comprise, for example, an extension member with a central axis of extension, along which the extension member is strained during a measurement. For example, the extension member may comprise a silicon chip with an integrated full bridge, which delivers a voltage that is proportional to its strain or compression. The piezoresistive strain sensor 19 particularly is realized with two freely programmable, independent measuring ranges for measuring forces such that the piezoresistive strain sensor 19 can measure, for example, high pressures and forces of 1000-3000 bar during injection and low dynamic pressures of 100-300 bar during plasticizing. In contrast to piezoelectric strain sensors, the piezoresistive strain sensor 19 no longer requires a reset/operate signal.

FIG. 6 shows that the injection slide 5 and the bearing housing 11 of the exemplary embodiment shown are realized in the form of an integral component 22 such that the injection slide 5 and the bearing housing 11 can be cast or injection-moulded in one manufacturing process and therefore form a single component.

In summary, the present disclosure pertains to a hydraulically or electromechanically driven injection device 1 for melting and injecting a plastic mass into a corresponding suitable mould of an injection moulding machine, wherein the injection device has at least one injection screw. The injection force, i.e. the force between the injection spindle 6 and the injection screw, is measured by means of the piezoresistive strain sensor, wherein the strain [sic] is attached to an existing force transmission component, in this case the injection slide 5, such that no additional deformation component is required for the force measurement. Accordingly, the direct attachment of the piezoresistive strain sensor 19 to existing components lying in the flux of force eliminates the need for additional connecting elements that serve as deformation component. In comparison with solutions known from the prior art, this allows a more direct force application, as well as a measuring point at an optimal location without adulteration due to frictional influences, and leads to a reduction of the components, the processing effort, the assembly and the manufacturing costs. The component, which until now was additionally required in solutions known from the prior art and the deformation of which can be measured by means of strain gauges, therefore is no longer needed.

The subject disclosure naturally is not limited to the described and illustrated embodiment. It is apparent that numerous modifications, which are obvious to a person skilled in the art for the respective intended use, can be carried out on the embodiment illustrated in the drawings without thereby deviating from the scope of the invention. For example, a person skilled in the art will realize that an injection piston can also be used instead of an injection screw and a hydraulic cylinder can be used instead of an injection spindle 6.

It will be appreciated that various implementations of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. An injection device for an injection moulding machine for melting and injecting a plastic mass into a mould of the injection moulding machine, comprising an injection drive, which has an injection spindle and a spindle nut and is designed so as to rotate the injection spindle relative to the spindle nut, an injection slide, which is connected to the spindle nut in a rotationally rigid manner on one lateral surface and held so as to be movable along a slide guide, a guide housing, on which a plasticizing cylinder is held on the side facing away from the injection slide, a bearing housing, which is arranged between the guide housing and the injection slide and in which a driveshaft is rotatably supported, wherein said driveshaft can be drive-connected to an injection screw that is movably arranged within the plasticizing cylinder, and wherein said bearing housing is connected to the injection slide on a lateral surface of the injection slide facing away from the spindle nut, as well as a metering drive that is fastened on the injection slide and designed so as to rotate the driveshaft,
wherein
a force measuring device, which determines at least an injection force, is externally fastened on a force transmission component that is arranged between the bearing housing and the spindle nut and lies in the flux of force of the injection device.

2. The injection device according to claim 1, wherein the force transmission component is formed by the injection slide.

3. The injection device according to claim 1, wherein the injection slide and the bearing housing are realized in the form of an integral component.

4. The injection device according to claim 1, wherein the force measuring device is realized in the form of a piezoresistive strain sensor.

5. The injection device according to claim 4, wherein the piezoresistive strain sensor is arranged on the injection slide in the direct flux of force and externally fastened on the injection slide.

6. The injection device according to claim 4, wherein the piezoresistive strain sensor is realized with two freely programmable, independent measuring ranges for the force measurement.

7. The injection device according to claim 4, wherein the piezoresistive strain sensor is designed for an indirect force measurement by measuring the force-proportional strain of the surface of the force transmission component.

8. The injection device according to claim 4, wherein the piezoresistive strain sensor is aligned in the longitudinal direction of the injection spindle.

9. The injection device according to claim 4, wherein the piezoresistive strain sensor has a sensor housing, which is fastened on a surface of the force transmission component at a distance from its surface.

10. The injection device according to claim 1, wherein the injection drive comprises a motor-driven toothed wheel and a toothed belt that is drive-connected to the injection spindle.

11. The injection device according to claim 2 wherein the injection slide and the bearing housing are realized in the form of an integral component.
